(19) United States
(12) Patent Application Publication
(10) Pub. No.: US 2011/0232621 A1
(43) Pub. Date: Sep. 29, 2011

(54) Portable stone shaper

(76) Inventor: Marciano Capuzzi, Havertown, PA (US)

(21) Appl. No.: 13/065,590

(22) Filed: Mar. 24, 2011

Related U.S. Application Data
(60) Provisional application No. 61/340,954, filed on Mar. 25, 2010.

(51) Int. Cl. B28D 7/04

(52) U.S. Cl. 125/35

(57) ABSTRACT

The present invention provides a portable stone shaper resembling a tabletop jigsaw, this machine contains operational components germane to larger stone and tile cutters. Yet, in addition to its compact size, the Portable Stone Cutter embodies other unique design features. First, the base of the unit contains a two inch water tank and pump mechanism. This component facilitates proper lubrication, as well as safe and pristine finishes. Additionally, the device of the present invention is able to use virtually any type of common or specialized bits for cutting. Easily interchangeable, the versatility of the bit usage ensures that one has any bit needed for any job at all times. The Portable Stone Cutter can be sold with a standard bit selection and other bit designs made especially for this product are sold separately, as an aftermarket product. The device of the present invention operates on conventional one hundred ten volts, sixty hertz power and is connected to a standard power outlet. As such, the Portable Stone Cutter is easily placed on a countertop in a kitchen undergoing renovation or in a garage shop. By simply plugging in the unit, choosing a bit, and placing a stone or tile onto the unit, a user simply glides the tile through the machine, which generates a lubricated cut and quickly shapes and finishes the edge.

### CLAIM OF PRIORITY

This patent application claims priority under 35 USC 119 (e) (1) from U.S. Provisional Patent Application Ser. No. 61/340,954 filed Mar. 25, 2010, of common inventorship herewith entitled, “Portable Stone Shaper.”

### FIELD OF THE INVENTION

The present invention pertains to the field of tile cutting devices, and more specifically to the field of portable tile cutting and shaping devices.

### BACKGROUND OF THE INVENTION

The prior art has put forth several designs for portable tile cutting and shaping devices. Among these are:

U.S. Pat. No. 2,450,523 to Charles F. Parker describes an invention which relates to improvements in portable cutting or sawing machines and more particularly to an improved portable machine for cutting tile, slate, paving stone and other flat objects of hard material.

U.S. Pat. No. 4,817,581 to Frederick Trentadue describes a cutting tool such as a tile saw pivotally connected to a linear guide rod with a four-bar linkage. The linkage allows the cutting tool to be raised and lowered over a work table to facilitate plunge cutting.

U.S. Pat. No. 6,712,061 to Robert M. Kalb describes a portable apparatus for working, shaping and polishing stone and other hard materials. A preferred contouring guide allows a tool to be moved through an arc, where the focal point of the arc may be set to produce an infinite variety of custom shapes, bevels or angles of cut.

None of these prior art references describe the present invention.

### SUMMARY OF THE INVENTION

It is an object of the present invention to provide a portable tile cutting and shaping device.

### BRIEF DESCRIPTION OF THE DRAWINGS

FIG. 1 is a 3-D isometric view of the table portion of the device of the present invention.

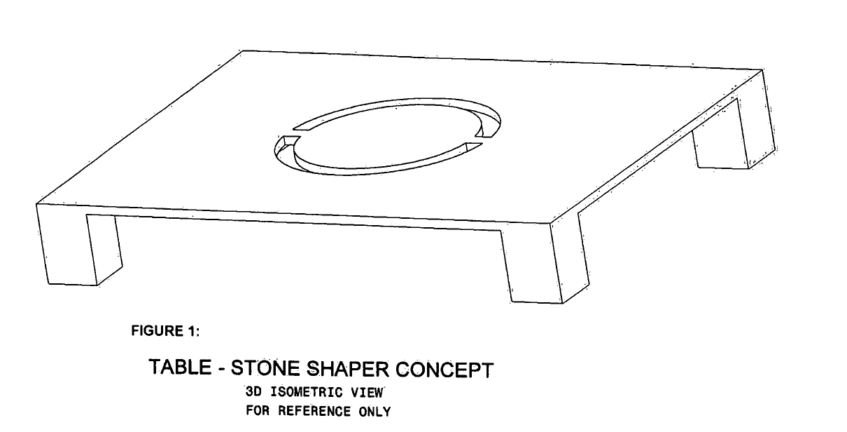

FIG. 2 shows top and side views of the table portion of the device of the present invention.

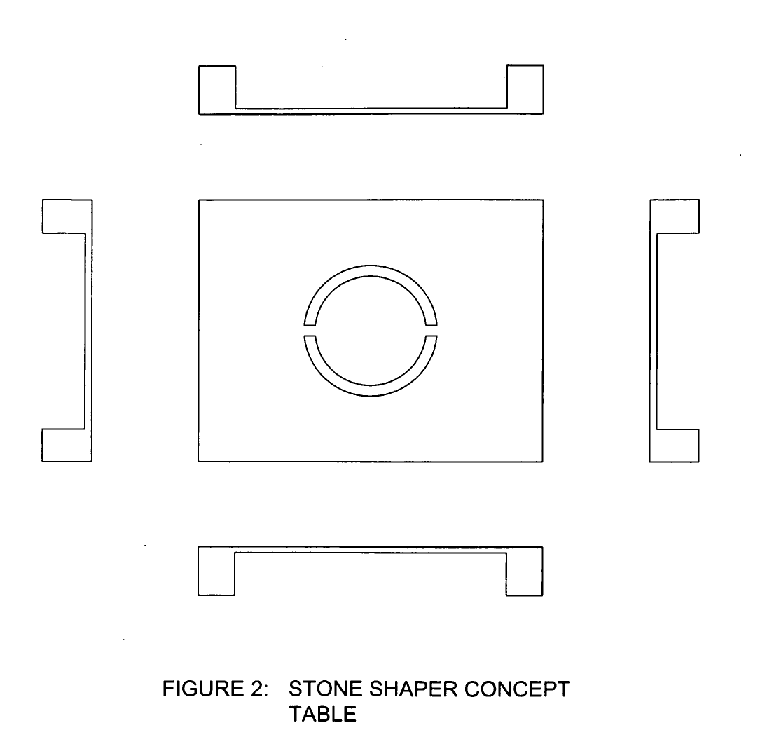

FIG. 3 is a 3-D isometric view of the router housing portion of the device of the present invention.

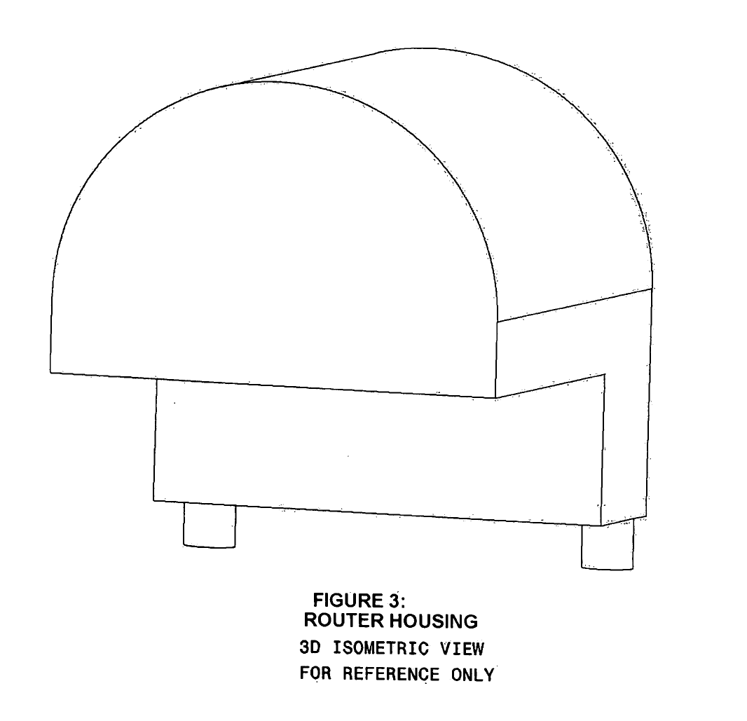

FIG. 4 shows top and side views of the router housing portion of the device of the present invention.

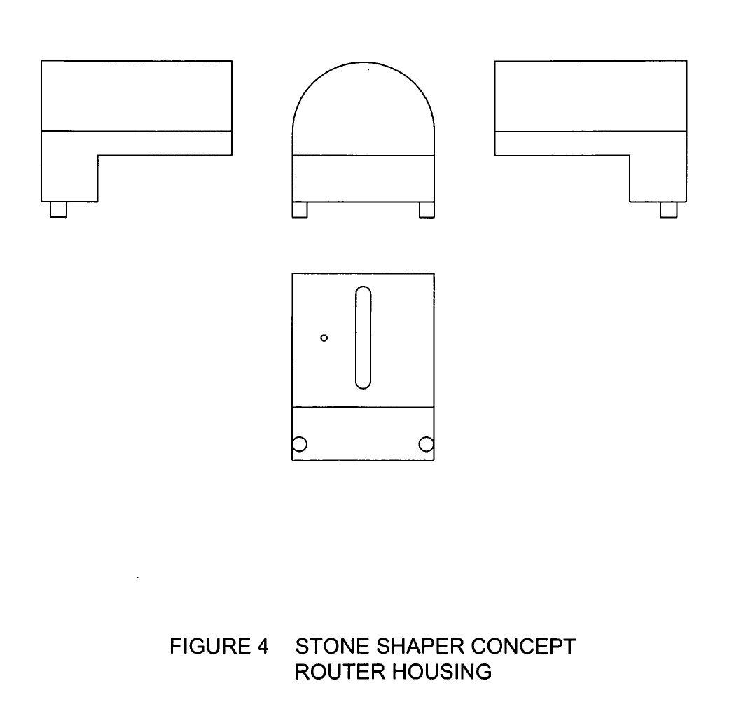

FIG. 5 is a 3-D isometric view of the reservoir portion of the device of the present invention.

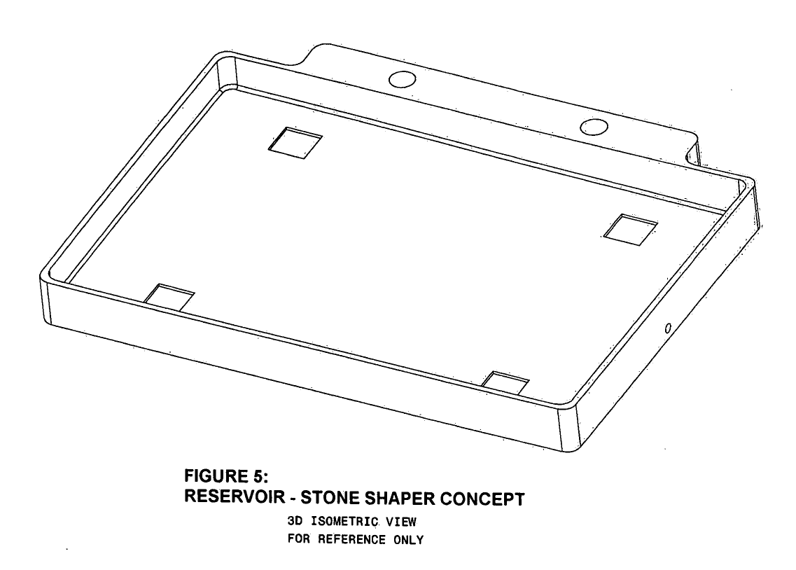

FIG. 6 shows top and side views of the reservoir portion of the device of the present invention.

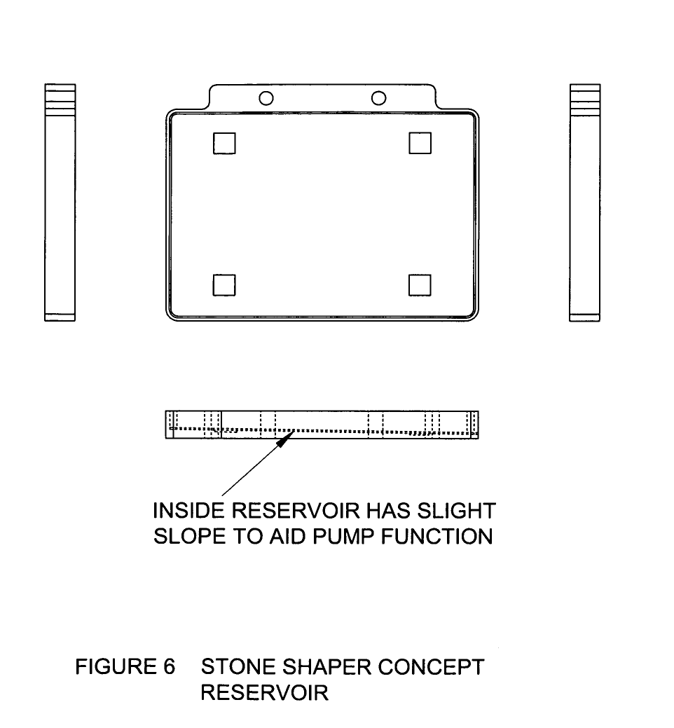

FIG. 7 is a 3-D isometric view of the full assembly of the device of the present invention.

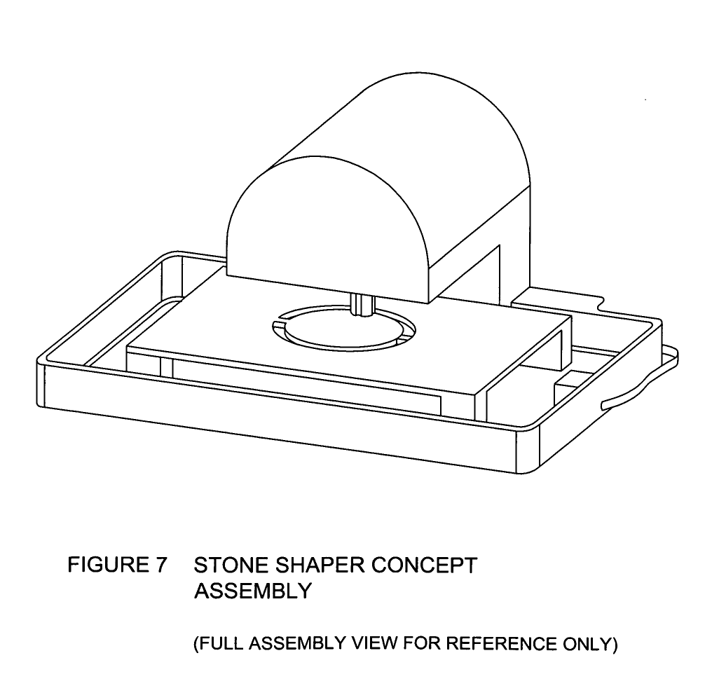

### DETAILED DESCRIPTION OF THE INVENTION

The present invention, hereinafter referred as the Portable Stone Shaper, is a specially designed stone and tile cutter that is easily transported and used anywhere. In this manner, professionals and do-it-yourselfers have a more affordable, time saving means of shaping stone and tile that eliminates the need to continuously rely on a factory for this purpose. Fabricated of a durable metal material, the Portable Stone Shaper is essentially rectangular in shape, featuring dimensions of approximately one foot by two feet by sixteen inches.

Resembling a tabletop jigsaw, this machine contains operational components germane to larger stone and tile cutters. Yet, in addition to its compact size, the Portable Stone Cutter embodies other unique design features. First, the base of the unit contains a two inch water tank and pump mechanism. This component facilitates proper lubrication, as well as safe and pristine finishes.

Additionally, the device of the present invention is able to use virtually any type of common or specialized bits for cutting. Easily interchangeable, the versatility of the bit usage ensures that one has any bit needed for any job at all times. The Portable Stone Cutter can be sold with a standard bit selection and other bit designs made especially for this product are sold separately, as an aftermarket product. The device of the present invention operates on conventional one hundred ten volts, sixty hertz power and is connected to a standard power outlet. As such, the Portable Stone Cutter is easily placed on a countertop in a kitchen undergoing renovation or in a garage shop. By simply plugging in the unit, choosing a bit, and placing a stone or tile onto the unit, a user simply glides the tile through the machine, which generates a lubricated cut and quickly shapes and finishes the edge.

Professionals certainly appreciate the portability of this product, as it allows them to take the device from job to job and complete the work on-site, instead of making repeated trips to a tile factory. This not only saves time, but also allows professionals to pass time and money savings to their clients. Providing efficiency and practicality, the Portable Stone Shaper is well received by those in the trade, as well as by motivated do-it-yourselfers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable cutting and shaping device, comprising a table top jigsaw further comprising a two inch deep water tank and pump mechanism to facilitate proper lubrication, as well as safe and pristine finishes, wherein the device is configured to use a wide variety of common or specialized bits for cutting, wherein the device is powered by conventional one hundred ten volts, sixty hertz power and is connected to a standard power outlet.

2. The portable cutting and shaping device of claim 1 suitable for use on tile.

3. The portable cutting and shaping device of claim 1 suitable for use on stone.
